(19) United States
(12) Patent Application Publication
(10) Pub. No.: US 2026/0012709 A1
(43) Pub. Date: Jan. 8, 2026

(54) MACHINING DEVICE AND IMAGE PROCESSING METHOD

(71) Applicant: TOKYO SEIMITSU CO., LTD., Tokyo (JP)

(72) Inventors: Riku SASAKI, Hachioji-shi (JP); Tomoki FUKE, Hachioji-shi (JP); Tasuku SHIMIZU, Hachioji-shi (JP)

(21) Appl. No.: 19/323,649

(22) Filed: Sep. 9, 2025

Related U.S. Application Data
(63) Continuation of application No. PCT/JP2024/011034, filed on Mar. 21, 2024.

(30) Foreign Application Priority Data
Mar. 23, 2023 (JP) 2023-047168

(51) Int. Cl. H04N 23/72; H04N 23/74; H04N 23/76

(52) U.S. Cl. CPC H04N 23/72; H04N 23/74; H04N 23/76

(57) ABSTRACT

A machining device acquires data including information regarding a machining condition of a workpiece and machines the workpiece under the machining condition recorded in the acquired data. The machining device includes: an irradiation unit configured to irradiate the workpiece with electromagnetic waves capable of transmitting through the workpiece; an imaging unit configured to image the workpiece irradiated with the electromagnetic waves; a preprocessing unit configured to generate a second image by executing preprocessing on a first image obtained by the imaging; and an image processing unit configured to execute image processing on the second image. The data acquired by the machining device includes information regarding a processing condition of the preprocessing. The preprocessing unit generates the second image by executing preprocessing on the first image under the processing condition recorded in the data.

This application is a Bypass Continuation Application of PCT/JP2024/011034 filed on Mar. 21, 2024 which priority is claimed on Japanese Patent Application No. 2023-047168, filed Mar. 23, 2023, the content of which is incorporated herein by reference.

### TECHNICAL FIELD

The present invention relates to a machining device and an image processing method, and more particularly, to a machining device that processes a plate-shaped workpiece and an image processing method of processing an image of the workpiece imaged in the machining device.

### BACKGROUND ART

In machining devices such as slicers or dicers that execute grooving on machining targets such as workpieces, it is necessary to image the workpieces in some cases in order to recognize machining positions of the workpieces. At these times, electromagnetic waves such as infrared rays or X rays that can penetrate the workpieces are used to image the workpieces (see, for example, Patent Documents 1 to 4).

### CITATION LIST

### Patent Document

Patent Document 1: Japanese Unexamined Patent Application, First Publication No. H6-232255
Patent Document 2: Japanese Unexamined Patent Application, First Publication No. H7-75955
Patent Document 3: Japanese Unexamined Patent Application, First Publication No. 2008-109015
Patent Document 4: Japanese Unexamined Patent Application, First Publication No. 2015-159241

### SUMMARY OF INVENTION

### Technical Problem

Imaging is executed under optimal conditions by adjusting a focal position and an amount of electromagnetic radiation. However, the obtained image does not always have a quality suitable for image recognition or the like, and it has been necessary to adjust the quality of an image individually for each workpiece. For example, depending on the thickness of a workpiece, the thickness of a transmissive film, or a type of film, it has been necessary to individually adjust lightness and contrast for each workpiece. It is necessary for an operator (user) to manually execute this adjustment work. When a plurality of workpieces are involved, considerable effort is required.

The present invention has been made in view of such circumstances, and an object is to provide a machining device and an image processing method capable of automatically adjusting quality of an image according to the machining target.

### Solution to Problem

To solve the foregoing problems, a first aspect of a machining device according to the present disclosure is a machining device that acquires data including information regarding a machining condition of a workpiece and machines the workpiece under the machining condition recorded in the acquired data. The machining device includes: an irradiation unit configured to irradiate the workpiece with electromagnetic waves capable of transmitting through the workpiece; an imaging unit configured to image the workpiece irradiated with the electromagnetic waves; a preprocessing unit configured to generate a second image by executing preprocessing on a first image obtained by the imaging; and an image processing unit configured to execute image processing on the second image. The data includes information regarding a processing condition of the preprocessing. The preprocessing unit generates the second image by executing preprocessing on the first image under the processing condition recorded in the data.

A second aspect of the machining device according to the present invention is that the preprocessing unit executes a process of converting luminance as the preprocessing in the machining device according to the first aspect.

A third aspect of the machining device according to the present invention is that the preprocessing unit generates a table for converting luminance of the first image under the processing condition, and converts the luminance of the first image with reference to the generated table in the machining device according to the second aspect.

A fourth aspect of the machining device according to the present invention is that the preprocessing unit generates the table using a conversion formula in which a gain and/or an offset is included in a parameter, and the data includes information regarding the gain and/or the offset set with the conversion formula as the information regarding the processing condition in the machining device according to the third aspect.

A fifth aspect of the machining device according to the present invention is that the preprocessing unit generates a plurality of the tables by changing the gain and/or the offset step by step under a predetermined condition, generates a plurality of the second images by converting the luminance of the first image using the plurality of generated tables, and extracts one second image most appropriate for the image processing by the image processing unit among the plurality of generated second images in the machining device according to the fourth aspect.

A sixth aspect of the machining device according to the present invention is that the image processing unit executes alignment image processing on the second image in the machining device according to one of the first to fifth aspects.

A seventh aspect of the machining device according to the present invention is that a condition reception unit configured to receive the machining condition and the processing condition is further included in the machining device according to one of the first to sixth aspects.

An eighth aspect of the machining device according to the present invention is that the irradiation unit irradiates the workpiece with infrared rays as the electromagnetic waves in the machining device according to one of the first to seventh aspects.

A ninth aspect of the machining device according to the present invention is that the workpiece is machined along a planned division line in the machining device according to one of the first to eighth aspects.

A tenth aspect of the machining device according to the present invention is that the workpiece is machined along the planned division line with a rotating blade or a laser in the machining device according to the ninth aspect.

An eleventh aspect of the machining device according to the present invention is that the data further includes at least one of information regarding the workpiece and information regarding an alignment condition in the machining device according to one of the first to tenth aspects.

A twelfth aspect of the machining device according to the present invention is that the information regarding the alignment condition includes information regarding an irradiation amount of the electromagnetic waves and focus setting information during the imaging by the imaging unit, and the machining device further includes: an irradiation control unit configured to control irradiation of the electromagnetic waves by the irradiation unit based on the data; and an imaging control unit configured to control the imaging by the imaging unit based on the data in the machining device according to the eleventh aspect.

A first aspect of an image processing method according to the present invention is an image processing method of processing an image captured by irradiating a workpiece with electromagnetic waves capable of transmitting through the workpiece in a machining device that acquires data including information regarding a machining condition of the workpiece and machines the workpiece under the machining condition recorded in the acquired data. The image processing method includes: a preprocessing step of generating a second image by executing preprocessing on a first image obtained by the imaging; and an image processing step of executing image processing on the second image. The data includes information regarding a processing condition of the preprocessing. In the preprocessing step, the second image is generated by executing preprocessing on the first image under the processing condition recorded in the data.

A second aspect of the image processing method according to the present invention is that the preprocessing step includes a step of generating a table for converting luminance of the first image using a conversion formula in which a gain and/or an offset is included in a parameter, and a step of converting the luminance of the first image with reference to the generated table, and the data includes information regarding the gain and/or the offset set with the conversion formula as the information regarding the processing condition in the image processing method according to the first aspect.

A third aspect of the image processing method according to the present invention is that the preprocessing step further includes a step of generating a plurality of the tables by changing the gain and/or the offset step by step under a predetermined condition, a step of generating a plurality of the second images by converting the luminance of the first image using the plurality of generated tables, and a step of extracting one second image most appropriate for the image processing by the image processing unit among the plurality of generated second images in the image processing method according to the second aspect.

### Advantageous Effects of Invention

According to the present invention, it is possible to automatically adjust quality of a captured image according to a machining target workpiece.

### BRIEF DESCRIPTION OF DRAWINGS

FIG. 1 A front view representing an embodiment of a dicing device.

FIG. 2 A plan view representing the dicing device.

FIG. 3 A diagram representing a schematic configuration of an imaging unit.

FIG. 4 A block diagram representing a schematic configuration of a control system of the dicing device.

FIG. 5 A block diagram representing functions of an image processing unit.

FIG. 6 A graph representing an example of a conversion formula.

FIG. 7 A block diagram representing a main function of a preprocessing unit.

FIG. 8 A flowchart representing an example of an order of a process of generating a lookup table.

FIG. 9 A flowchart representing an example of an order of an alignment process.

FIG. 10 A block diagram representing a main function of the preprocessing unit.

FIG. 11 A flowchart representing an example of an order of a process of generating a lookup table.

FIG. 12 A flowchart representing an example of an order of a preprocessing process.

### DESCRIPTION OF EMBODIMENTS

Hereinafter, preferred embodiments of the present invention will be described with reference to the appended drawings.

### First Embodiment

Here, a case in which the present invention is applied to a dicing device will be described as an example. The dicing device is a device that executes grooving on a workpiece that is a machining target. In particular, in the present embodiment, a case in which the present invention is applied to a blade dicer will be described as an example.

The blade dicer uses a high-speed rotating blade to machine a wafer or form grooves in a wafer. In the present embodiment, the dicing device is an example of a machining device.

A machining target wafer is, for example, a semiconductor wafer on which integrated circuits (ICs) or the like are formed. This wafer is a patterned wafer. ICs and the like are formed in grid-like regions partitioned by streets. Streets are regions on the wafer that can be cut. The blade dicer machines the wafer along the streets with a blade to divide the wafer into individual chips. The wafer is an example of a workpiece, and the streets are examples of partitioned scheduled lines.

In the present embodiment, a case in which the pattern surface that is a surface on which ICs or the like are formed cannot be observed under visible light will be described as an example. This case is, for example, a case in which a pattern surface is not located on a cutting surface that is a surface on which cutting is executed or grooves are machined with a blade, a case in which a pattern surface is covered with an opaque protective film, or the like. The case in which a pattern surface is not located on a cutting surface is, for example, a case in which a pattern surface (front surface) faces down, in other words, a case in which a back surface is machined as a cutting surface, a case in which a pattern surface is located inside a stacked wafer, a case in which a pattern surface is covered with an opaque protective film, or the like. The case in which a pattern surface is located inside a stacked wafer is, for example, a case in which a wafer having a so-called sandwich structure is machined, or the like. When a pattern surface cannot be observed under visible light, a wafer is observed or aligned using electromagnetic waves that can penetrate the wafer. As one example, a wafer is observed or aligned using infrared (IR) rays.

### [Device Configuration of Dicing Device]

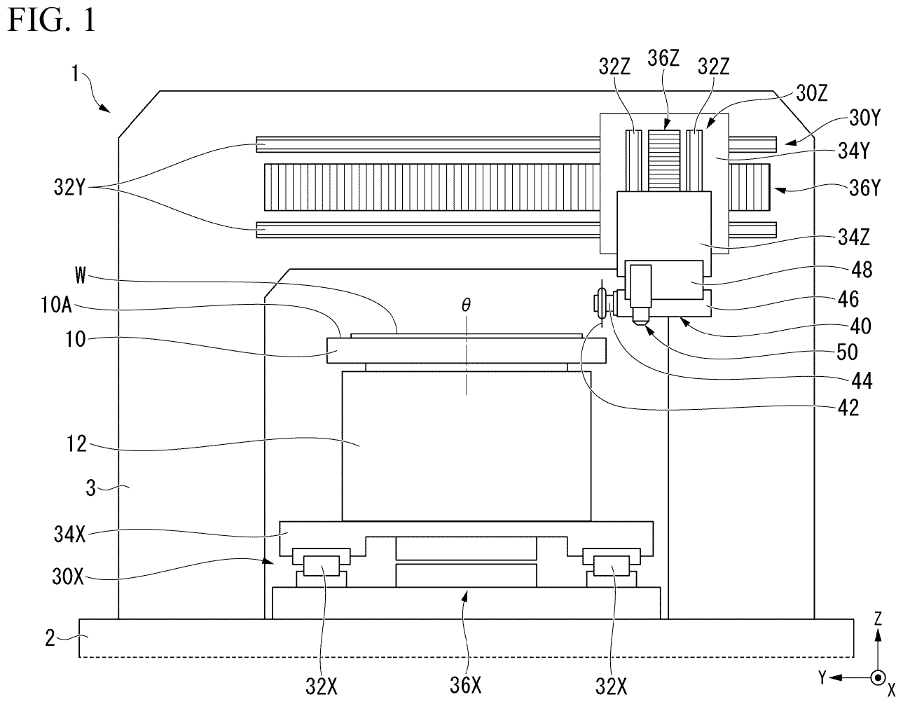

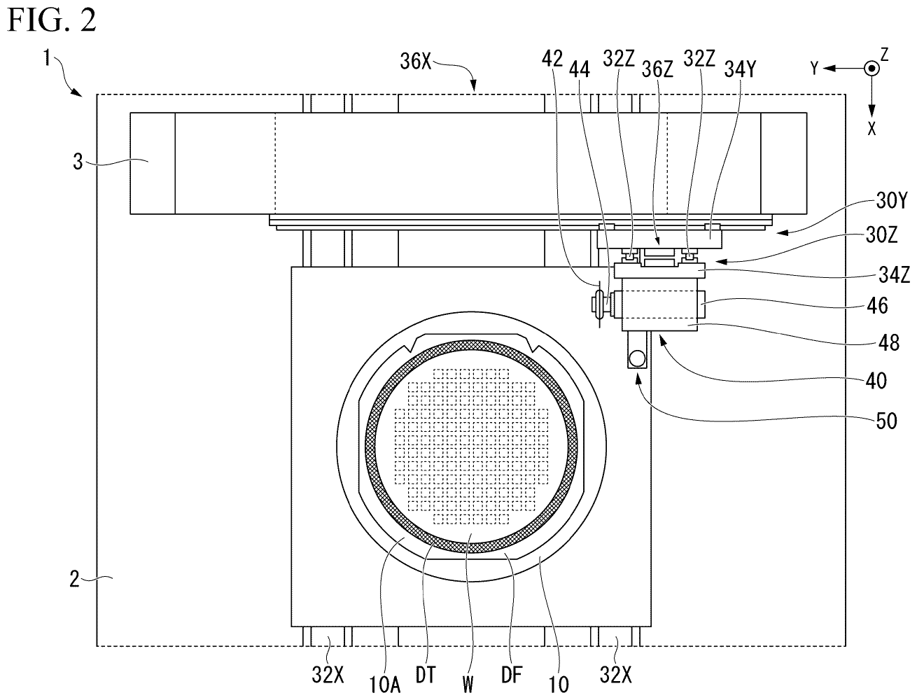

FIG. 1 is a front view representing an embodiment of a dicing device to which the present invention is applied. FIG. 2 is a plan view of the dicing device illustrated in FIG. 1.

In FIGS. 1 and 2, the X, Y, and Z axes are axes perpendicular to each other. A plane including the X and Y axes is a horizontal surface.

As illustrated in FIG. 1, a dicing device 1 according to the present embodiment includes, on a base 2, a workpiece table 10 holding a wafer W and an X-axis feed mechanism 30X that moves the workpiece table 10 in the X-axis direction.

The workpiece table 10 has a disk-shaped form and holds the wafer W by adsorption on a horizontal holding surface 10A. As an example, the workpiece table 10 holds the wafer W by vacuum adsorption.

As illustrated in FIG. 2, the wafer W is held on the workpiece table 10 while being mounted on a dicing frame DF. The wafer W has a disk-shaped form and is mounted on the dicing frame DF via a dicing tape DT.

In the present embodiment, the wafer W is mounted on the dicing frame DF with the pattern surface (front surface) facing downward. Accordingly, the wafer W is held on the workpiece table 10 with the pattern surface facing downward. That is, the wafer W is held on the workpiece table 10 with a surface on which there is no pattern (back side) facing upward.

The workpiece table 10 is driven by a workpiece table drive motor 12 and rotates around a θ axis. The θ axis passes through the center of the workpiece table 10 and is parallel to the Z axis. The workpiece table 10 has a reference point for rotation, and the position of this reference point (the rotational position relative to the origin) is detected by a rotation position detector (not illustrated). The rotation position detector is configured with, for example, a rotary encoder.

The X-axis feed mechanism 30X is a mechanism that moves the workpiece table 10 in the X-axis direction. The X-axis feed mechanism 30X includes an X-axis guide rail 32X, an X-axis table 34X, an X-axis actuator 36X, and an X-axis position detector (not illustrated). The X-axis guide rail 32X is provided on the base 2 in the X-axis direction. The X-axis table 34X is provided to be movable along the X-axis guide rail 32X. The X-axis actuator 36X moves the X-axis table 34X along the X-axis guide rail 32X. The X-axis actuator 36X is, for example, configured with a linear motor. An X-axis position detector (not illustrated) detects a position of the X-axis table 34X. The X-axis position detector is, for example, configured with a linear scale.

The workpiece table 10 is provided on the X-axis table 34X. By driving the X-axis actuator 36X and moving the X-axis table 34X in the X-axis direction, the workpiece table 10 is moved in the X-axis direction. By causing the X-axis position detector to detect a position of the X-axis table 34X, a position of the workpiece table 10 in the X-axis direction (relative to a reference point in the X-axis direction) is detected.

As illustrated in FIGS. 1 and 2, a column 3 is further provided on the base 2. The column 3 has a gate-shaped structure and is provided on the base 2 to span over the X-axis guide rail 32X.

The column 3 includes a machining unit 40 that machines the wafer W, an imaging unit 50 that images a front surface of the wafer W, a Y-axis feed mechanism 30Y that moves the machining unit 40 and the imaging unit 50 in the Y-axis direction, and a Z-axis feed mechanism 30Z that moves the machining unit 40 and the imaging unit 50 in the Z-axis direction.

The machining unit 40 machines the wafer W using a blade 42 rotating at a high speed. The machining unit 40 includes a spindle 44 on which the blade 42 is mounted and a spindle motor 46 that rotates the spindle 44. The spindle 44 is disposed parallel to the Y axis. The blade 42 is detachably mounted at the tip of the spindle 44. Since the blade 42 is detachable, the blade 42 can be exchanged. The blade 42 mounted on the spindle 44 rotates at a high speed around the axis by driving the spindle motor 46 and rotating the spindle 44 at a high speed.

The imaging unit 50 images the wafer W from vertically above. Here, as described above, the wafer W is held on the workpiece table 10 with a patterned surface facing downward. Therefore, even when the wafer W on the workpiece table 10 is observed under normal visible light, a pattern cannot be observed. Therefore, in the dicing device 1 according to the present embodiment, infrared rays are used to image the wafer W. Details of the imaging unit 50 will be described below.

The Y-axis feed mechanism 30Y is a mechanism that moves the machining unit 40 and the imaging unit 50 in the Y-axis direction. The Y-axis feed mechanism 30Y includes a Y-axis guide rail 32Y, a Y-axis table 34Y, a Y-axis actuator 36Y, and a Y-axis position detector (not illustrated). The Y-axis guide rail 32Y is provided on the column 3 in the Y-axis direction. The Y-axis table 34Y is provided to be movable along the Y-axis guide rail 32Y. The Y-axis actuator 36Y moves the Y-axis table 34Y along the Y-axis guide rail 32Y. The Y-axis actuator 36Y is configured with, for example, a linear motor. The Y-axis position detector (not illustrated) detects a position of the Y-axis table 34Y. The Y-axis position detector is configured at, for example, a linear scale.

The Z-axis feed mechanism 30Z is a mechanism that moves the machining unit 40 and the imaging unit 50 in the Z-axis direction. The Z-axis feed mechanism 30Z includes a Z-axis guide rail 32Z, a Z-axis table 34Z, a Z-axis actuator 36Z, and a Z-axis position detector (not illustrated). The Z-axis guide rail 32Z is provided on the Y-axis table 34Y in the Z-axis direction. The Z-axis table 34Z is provided to be movable along the Z-axis guide rail 32Z. The Z-axis actuator 36Z moves the Z-axis table 34Z along the Z-axis guide rail 32Z. The Z-axis actuator 36Z is configured with, for example, a linear motor. The Z-axis position detector (not illustrated) detects a position of the Z-axis table 34Z. The Z-axis position detector is configured at, for example, a linear scale.

The machining unit 40 and the imaging unit 50 are mounted on the Z-axis table 34Z with a bracket 48 interposed therebetween. Accordingly, when the Z-axis table 34Z is moved, the machining unit 40 and the imaging unit 50 move in the Z-axis direction. When the Y-axis table 34Y is moved, the machining unit 40 and the imaging unit 50 move in the Y-axis direction. By detecting the position of the Z-axis table 34Z using a Z-axis position detector (not illustrated), a position of the blade 42 in the Z-axis direction is detected. By detecting the position of the Y-axis table 34Y using a Y-axis position detector (not illustrated), a position of the blade 42 in the Y-axis direction is detected.

### [Imaging Unit]

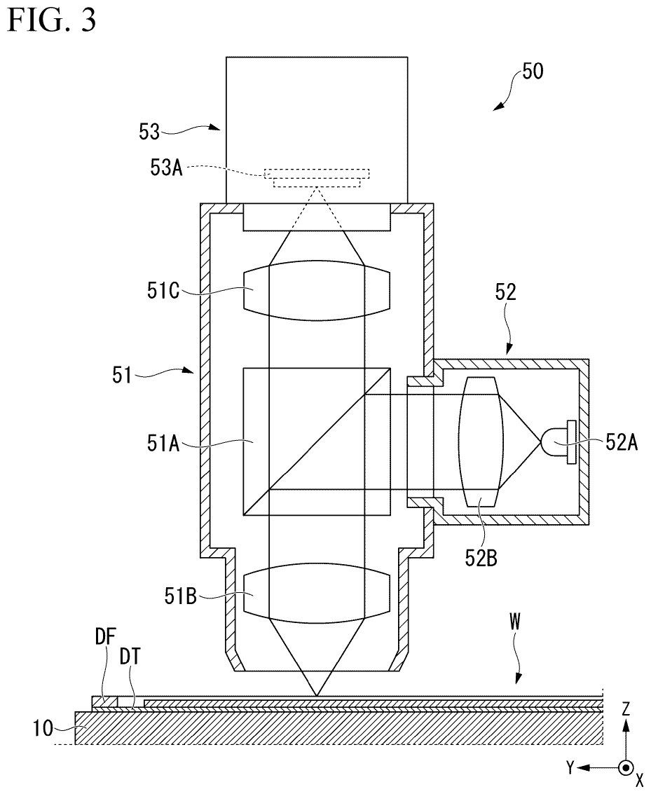

FIG. 3 is a diagram illustrating a schematic configuration of the imaging unit.

As described above, the imaging unit 50 according to the present embodiment images the wafer W on the workpiece table 10 using infrared rays. Hereinafter, the infrared rays are also referred to as infrared light.

As illustrated in FIG. 3, the imaging unit 50 includes a microscope unit 51, a light source unit 52, and a camera unit 53.

The microscope unit 51 includes a beam splitter 51A, an objective lens 51B, and an imaging lens 51C.

The light source unit 52 includes a light source 52A and a light source lens 52B. The light source 52A emits infrared rays. The light source 52A is configured with, for example, an infrared lamp, an infrared light emitting diode (LED), or the like. The light source lens 52B guides the infrared rays emitted from the light source 52A to the microscope unit 51. More specifically, the light source lens 52B causes the infrared rays to be incident on the beam splitter 51A.

The wafer W on the workpiece table 10 is irradiated with the infrared rays incident on the beam splitter 51A via the objective lens 51B. Then, the light reflected from the wafer W is incident on the camera unit 53 via the objective lens 51B, the beam splitter 51A, and the imaging lens 51C.

The camera unit 53 includes an image sensor 53A and electronically captures an image of the wafer W using infrared rays. As the image sensor 53A, an area image sensor such as a complementary metal oxide semiconductor image sensor (CMOS image sensor) or a CCD image sensor (charge-coupled device image sensor) is used.

In the present embodiment, a combined configuration of the light source 52A, the light source lens 52B, the beam splitter 51A, and the objective lens 51B is an example of an irradiation unit. The combined configuration of the microscope unit 51 and the camera unit 53 is an example of an imaging unit.

### [Configuration of Control System of Dicing Device]

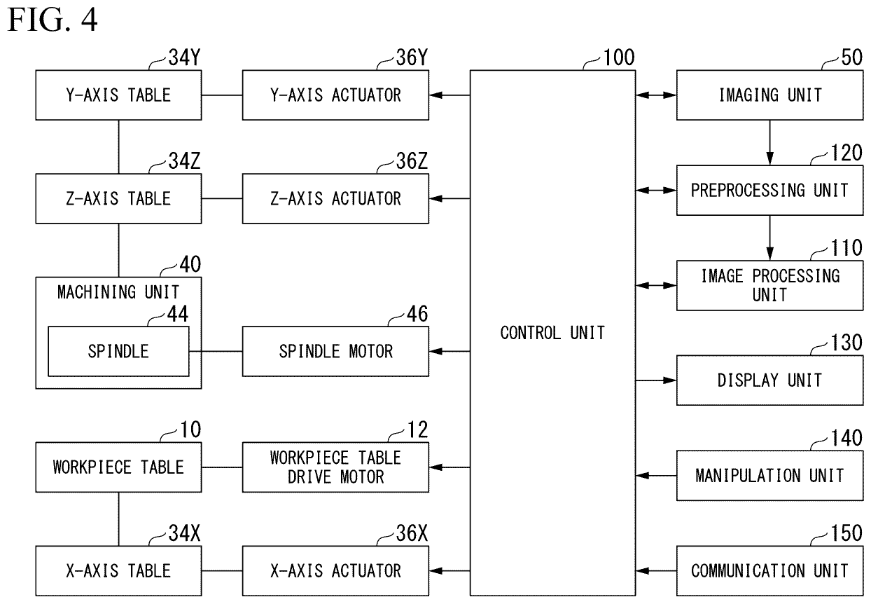

FIG. 4 is a block diagram representing a schematic configuration of a control system of the dicing device.

The dicing device 1 includes a control unit 100 that centrally controls an overall operation of the device, an image processing unit 110 that processes an image captured by the imaging unit 50, a preprocessing unit 120 that executes preprocessing on the image to be processed by the image processing unit 110, a display unit 130 that displays various types of information, a manipulation unit 140 that allows an operator (user) to execute various manipulations, and a communication unit 150 that communicates with an external device.

The control unit 100, the image processing unit 110, and the preprocessing unit 120 are configured as a computer that includes a processor, a memory, and an auxiliary storage device. That is, the computer functions as the control unit 100, the image processing unit 110, and the preprocessing unit 120 by executing a predetermined program. The processor is configured with, for example, a central processing unit (CPU).

The memory includes not only a random access memory (RAM) as a main memory but also a read only memory (ROM) or a flash memory. The auxiliary storage device is configured with, for example, a hard disk drive (HDD), a solid state drive (SSD), a flash memory, or the like. The control unit 100, the image processing unit 110, and the preprocessing unit 120 may also be configured as separate computers.

The display unit 130 is configured with, for example, a liquid crystal display (LCD), an organic electroluminescence display, or the like. The manipulation unit 140 is configured with, for example, a touch panel, a keyboard, a manipulation panel, or the like. The communication unit 150 communicates with an external device via wired or wireless connection in conformity with a known communication standard.

### [Function of Control Unit]

The control unit 100 controls the workpiece table drive motor 12 to regulate the rotation of the workpiece table 10. The control unit 100 also controls the X-axis actuator 36X to regulate the feed of the workpiece table 10 in the X-axis direction. The control unit 100 controls the Y-axis actuator 36Y to control feeding of the machining unit 40 in the Y-axis direction. The control unit 100 controls the Z-axis actuator 36Z to control feeding of the machining unit 40 in the Z-axis direction. The control unit 100 also controls the spindle motor 46 to control rotation of the spindle 44.

During machining, the dicing device 1 controls an orientation (posture) of the wafer W relative to the blade 42 by controlling the rotation of the workpiece table 10.

During machining, the dicing device 1 controls feeding of the workpiece table 10 in the X-axis direction to control feeding in a cutting direction (cutting feeding). The dicing device 1 also controls feeding of the machining unit 40 in the Y-axis direction to control feeding in a direction orthogonal to the cutting direction (index feeding). By controlling the feeding of the machining unit 40 in the Z-axis direction, the dicing device 1 regulates the feed in the depth direction (cut-in feed).

The machining of the wafer W is executed according to a recipe. The control unit 100 machines the wafer W by controlling each unit based on the machining conditions recorded in the recipe. Details of the recipe will be described below.

The control unit 100 controls the imaging unit 50 to manage the imaging of the wafer W. Imaging control includes focusing control and exposure control. The focusing control is executed through autofocus control, and exposure control is automatic exposure control. The exposure control includes controlling an irradiation amount of infrared light (an amount of infrared light). In the present embodiment, the control unit 100 is an example of both an irradiation control unit and an imaging control unit.

### [Function of Image Processing Unit]

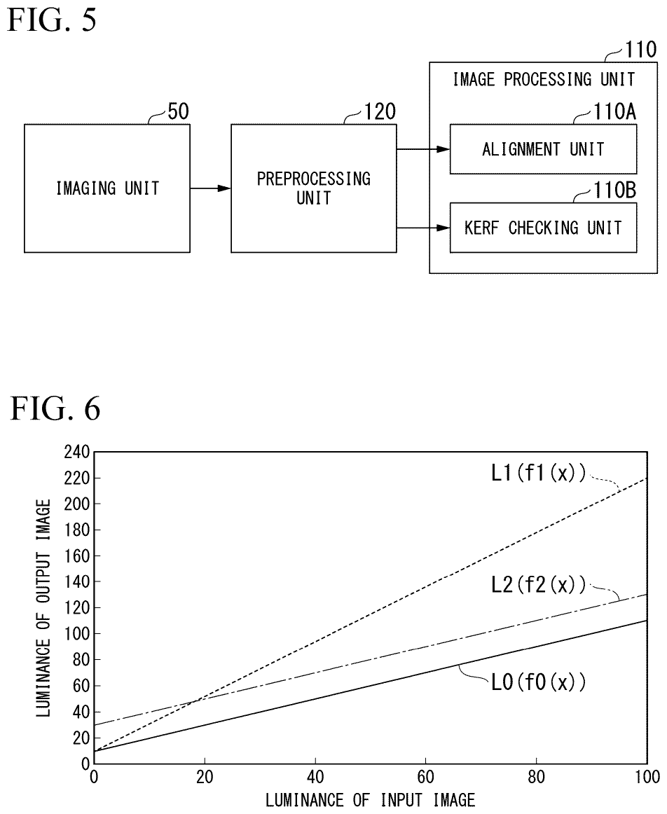

FIG. 5 is a block diagram representing functions of an image processing unit.

As illustrated in FIG. 5, the image processing unit 110 has functions such as an alignment unit 110A and a kerf checking unit 110B.

The alignment unit 110A executes an alignment process in cooperation with the control unit 100. The alignment refers to an operation of calculating a position of a street. The position of the street is calculated, for example, using an alignment mark as a reference. The alignment mark is a mark attached on the wafer W for the alignment. The alignment mark is also referred to as an alignment target. The alignment unit 110A processes an image captured by the imaging unit 50 to detect the alignment mark within the image. More specifically, the alignment unit 110A executes so-called image recognition, which involves recognizing the alignment mark within the image through image analysis.

The kerf checking unit 110B executes kerf checking based on the image captured by the imaging unit 50. The kerf checking is a process of verifying whether the blade 42 is machining at a correct position on the wafer W. The kerf checking includes detection of cut misalignment, detection of chipping, and detection of a kerf width. The kerf checking is executed at a predetermined frequency and at a preset position. The kerf width is, for example, a width in the thickness direction of the blade 42 on a groove machined by the blade 42. The kerf width may be a width of an upper end of the groove machined by the blade 42, the width of a bottom portion of the groove, or a width between the upper end and the bottom portion of the groove.

### [Function of Preprocessing Unit]

The preprocessing unit 120 receives an input of the image captured by the imaging unit 50, applies a predetermined process (preprocessing), and outputs the processed image to the image processing unit 110. Specifically, the preprocessing unit 120 executes processing for converting the image captured by the imaging unit 50 into an image that has quality appropriate for image processing by the image processing unit 110. As an example, in the present embodiment, the preprocessing unit 120 executes a process of converting the luminance (brightness) of the image.

In the present embodiment, the process of converting luminance of an image is executed with reference to a lookup table (LUT). More specifically, a process of converting a luminance value (pixel value) of each pixel and converting luminance of an image with reference to the lookup table is executed. The lookup table is one example of a table.

In the lookup table, a luminance value before the conversion and a luminance value after the conversion are paired and stored in a one-to-one correspondence. Accordingly, the luminance value to be converted is uniquely determined with reference to the lookup table.

The lookup table is generated using a predetermined conversion formula. The lookup table is generated for each machining target wafer W.

FIG. 6 is a graph representing an example of a conversion formula.

In the graph of FIG. 6, the horizontal axis represents a luminance value of an input image, and the vertical axis represents a luminance value of an output image. In other words, the luminance value of the input image is a luminance value before conversion, and the luminance value of the output image is a luminance value after conversion.

The conversion formula of the graph illustrated in FIG. 6 includes a gain and an offset as parameters. In the present embodiment, the gain and offset are set for each wafer W.

Here, in FIG. 6, a graph L0 indicated by a solid line is a graph of a conversion formula f0(x) set for a certain wafer.

In FIG. 6, a graph L1 indicated by a dashed line is a graph when the gain parameter is changed in the conversion formula f0(x). Specifically, FIG. 6 illustrates a graph when the gain is increased. A conversion formula in which the gain parameter is changed in the conversion formula f0(x) is referred to as f1(x).

In FIG. 6, a graph L2 indicated by a one-dot chain line is a graph when the offset parameter is changed in the conversion formula f0(x). Specifically, FIG. 6 illustrates the graph when the offset is increased. A conversion formula in which the offset parameter is changed in the conversion formula f0(x) is referred to as f2 (x).

As illustrated in FIG. 6, when the gain and the offset are included in parameters and the gain parameter is changed, a slope of the graph is changed. When the offset parameter is changed, an intercept of the graph is changed.

For the gain, the slope of the graph changes. Therefore, when the gain parameter changes, a resolution of the converted luminance is changed.

For the offset, the intercept of the graph changes. Therefore, when the offset parameter changes, the luminance of an entire image is changed.

The luminance required for image processing in the image processing unit 110 is adjusted using the gain and offset parameters.

Before the process of machining the wafer W starts, the preprocessing unit 120 acquires information regarding setting values of the gain and the offset set in the conversion formula and generates a lookup table based on the acquired information. Then, based on the generated lookup table, a luminance conversion process is executed.

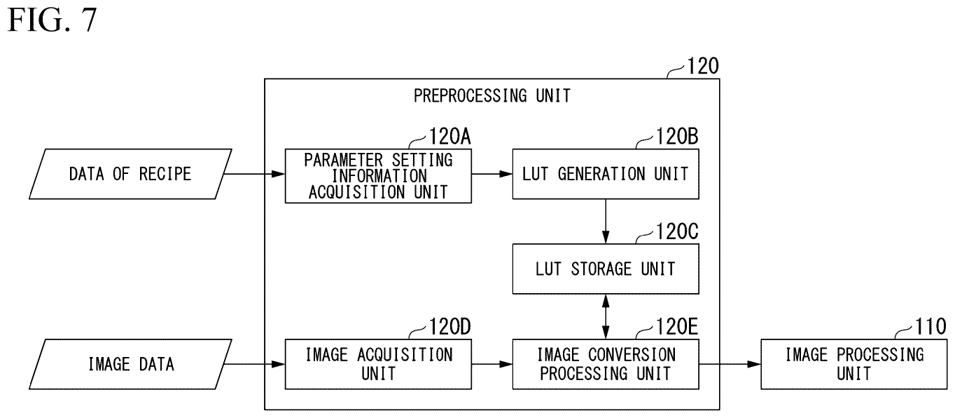

FIG. 7 is a block diagram representing a main function of a preprocessing unit.

As illustrated in FIG. 7, the preprocessing unit 120 includes functions of a parameter setting information acquisition unit 120A, a lookup table generation unit (LUT generation unit) 120B, a lookup table storage unit (LUT storage unit) 120C, an image acquisition unit 120D, and an image conversion processing unit 120E. The functions of the parameter setting information acquisition unit 120A, the lookup table generation unit 120B, the image acquisition unit 120D, and the image conversion processing unit 120E are implemented by a processor included in the preprocessing unit 120 executing a predetermined program. The lookup table storage unit 120C is implemented by a memory or an auxiliary storage device included in the preprocessing unit 120.

The parameter setting information acquisition unit 120A acquires setting information for the parameters included in the conversion formula. That is, the parameter setting information acquisition unit 120A acquires the setting information for the gain and the offset. In the present embodiment, the parameter setting information is included in the data of the recipe. The recipe will be described below. The parameter setting information acquisition unit 120A acquires the data of the recipe and acquires the information regarding the parameter setting values included in the data of the recipe. More specifically, the parameter setting information acquisition unit 120A acquires the information regarding the setting values of the gain and the offset included in the data of the recipe. The information regarding the setting values of the gain and the offset is one example of information regarding the processing condition of the preprocessing.

The lookup table generation unit 120B generates a lookup table using a predetermined conversion formula. As described above, the conversion formula includes gain and offset as parameters. The lookup table generation unit 120B sets the conversion formula based on the gain and offset setting values obtained by the parameter setting information acquisition unit 120A and generates a lookup table using the configured conversion formula. In other words, it generates a lookup table that executes a one-to-one conversion of luminance values. The lookup table is generated to match the range of luminance values in the input image. For example, if the input image has 255 grayscale levels (8-bit), a lookup table with 225 levels is generated.

The lookup table storage unit 120C stores the lookup table generated by the lookup table generation unit 120B.

The image acquisition unit 120D acquires a processing target image (image data). The processing target image is an image captured by the imaging unit 50. The image acquisition unit 120D acquires image data output from the imaging unit 50. The image acquired by the image acquisition unit 120D is an example of a first image.

The image conversion processing unit 120E executes a luminance conversion process on the image acquired by the image acquisition unit 120D. The image conversion processing unit 120E executes a process of converting a luminance value of each pixel and converting the luminance of the image with reference to the lookup table stored in the lookup table storage unit 120C. The image acquired by the image acquisition unit 120D is an example of the first image, and the image with the luminance converted by the image conversion processing unit 120E is an example of a second image.

The image with the luminance converted by the image conversion processing unit 120E is output to the image processing unit 110. The image processing unit 110 executes predetermined image processing on the image with the converted luminance. The predetermined image processing is image processing for alignment, image processing for kerf checking, or the like.

### [Recipe]

As described above, in the dicing device 1 according to the present embodiment, the wafer W is machined according to a recipe.

In general, a manufacturing apparatus used to manufacture a product, a plurality of parameters for designating an operation of the manufacturing apparatus for each manufacturing step are set. A set of the parameters is referred to as a “recipe.”

In a dicing device, in addition to parameters of machining conditions and alignment conditions of a workpiece, information regarding the workpiece is also stored as the recipe and is managed as the recipe for each type of workpiece or each machining condition. Here, the machining conditions are synonymous with machining methods, and the alignment conditions are synonymous with alignment methods. The information regarding the workpiece is also referred to as “device data” in some cases.

The information regarding the workpiece includes, for example, information regarding a workpiece size, information regarding a workpiece thickness, and information regarding a tape thickness. The information regarding the workpiece size is information regarding a size of a machining target. In the case of a circular workpiece, the size of the machining target is a diameter. In the case of a rectangular workpiece, the size of the machining target is a length and width. Based on the information regarding the workpiece size, a movement range of the blade is determined.

The parameters of the machining conditions of the workpiece include, for example, a setting value of an index, a setting value of a feed rate, a setting value of a spindle rotation speed, and a setting value of a blade height. The index refers to a feed amount in the Y-axis direction. The feed rate is a feed speed of the blade during cutting. Accordingly, the feed rate is a feed speed in the X-axis direction. The blade height is a distance between the holding surface 10A of the workpiece table 10 and the blade 42 during cutting. A cutting depth or a remaining uncut depth is controlled with the blade height.

The parameters of the alignment conditions include, for example, a setting value of illumination and a setting value of focus. The setting value of illumination is a set value for an amount of illumination light. In imaging in which infrared rays (radiant rays) are used, the setting value of illumination is a setting value of an amount of infrared rays. The setting value of focus is a set value for a position at which focusing is achieved. Here, the setting value for the amount of infrared rays is synonymous with a setting value for an amount of infrared light.

Various parameters in the recipe are set by an operator using the display unit 130 and the manipulation unit 140. For example, a predetermined setting screen is displayed on the display unit 130, and the operator inputs the setting values for each parameter through the manipulation unit 140. In this case, a combination of the display unit 130 and the manipulation unit 140 configures a condition reception unit that receives the machining conditions and the preprocessing conditions. Additionally, information regarding the setting values of the parameters may be acquired through the communication unit 150.

The information regarding the configured recipe (parameter setting information) is stored in an auxiliary storage device in association with the information for identifying the wafer W. Accordingly, when the same type of wafer W under is machined under the same conditions after a subsequent time, the data of the recipe can be retrieved and set from the auxiliary storage device. Accordingly, it is possible to reduce a burden on the operator setting the recipe.

Additionally, the data of the recipe can also be stored in association with the machining conditions or the like. Accordingly, it is possible to retrieve and use the data of the recipe based on the machining conditions.

In the dicing device 1 according to the present embodiment, the recipe includes information necessary for processing executed by the preprocessing unit 120. That is, information regarding the preprocessing conditions is included. Specifically, it contains information regarding the setting values of the parameters of the conversion formula used to generate the lookup table for luminance value conversion.

As described above, in the dicing device 1 according to the present embodiment, the gain and the offset are included as parameters of the conversion formula used to generate the lookup table. Accordingly, information regarding the setting values of the gain and the offset is included as the information regarding the processing conditions of the preprocessing.

The gain and the offset are set by the operator as in the setting of the machining conditions. For example, a predetermined setting screen may be displayed on the display unit 130, and an input of the setting values for the parameters is received through the manipulation unit 140 from the operator. The setting may be configured either on the same screen as the screen used to set machining conditions or on a separate screen. Additionally, the information regarding the setting values of the gain and the offset can be acquired externally through the communication unit 150.

In this way, in the dicing device 1 according to the present embodiment, the information required for preprocessing is included in the recipe. By acquiring the data of the recipe, information necessary for the preprocessing can be acquired. Since the recipe is set for each machining target, information necessary for the preprocessing can be acquired for each machining target.

In the present embodiment, the information or the data of the recipe is one example of data that includes information regarding the machining conditions of the workpiece.

### [Operational Effect of Dicing Device]

Here, an operation of the dicing device 1 according to the present embodiment will be explained focusing on a process for an image captured by the imaging unit 50. In particular, a process when alignment is executed will be described.

As described above, the alignment is an operation of calculating a position of a street. In the present embodiment, the image captured by the imaging unit 50 is processed to detect an alignment mark in an image and determine the position of the street.

First, a recipe is set for the machining target wafer W. As described above, the recipe is set using a predetermined setting screen. When a previously used recipe is reused, data of the corresponding recipe is read from the auxiliary storage device to set the recipe. Additionally, the data of the recipe can also be acquired and set from the outside through the communication unit 150.

The recipe to be set includes information necessary for a process by the preprocessing unit 120, that is, information required for generating the lookup table. In the present embodiment, the set recipe includes the gain and the offset that are setting information for the parameters of the conversion formula.

Here, the gain and the offset of the conversion formula are set from the perspective of image processing. That is, the gain and the offset values are set so that an image has a luminance appropriate for image processing. In the present embodiment, values of the gain and the offset are set so that an image has luminance appropriate for detecting an alignment mark or kerf.

Alignment is executed according to the set recipe. After the alignment is completed, the wafer W is machined according to the recipe.

In the dicing device 1 according to the present embodiment, before the alignment, the lookup table required for a process (preprocessing) by the preprocessing unit 120 is generated.

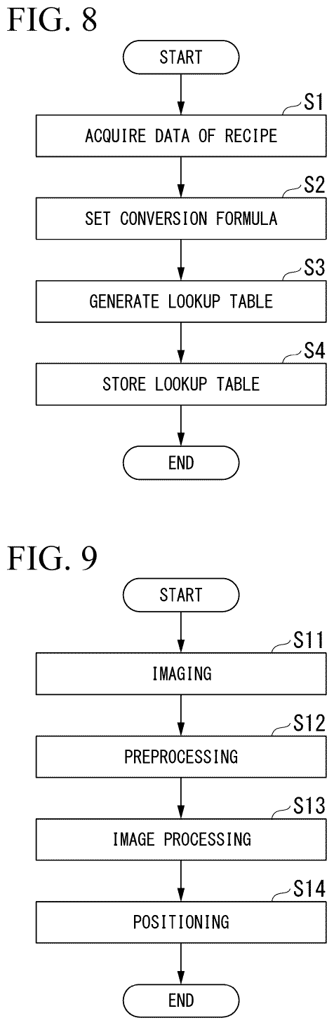

FIG. 8 is a flowchart representing an example of an order of a process of generating a lookup table.

First, data of the recipe is acquired (step S1).

Subsequently, the setting information for the parameters of the conversion formula is read from the data of the acquired recipe, and the conversion formula is set (step S2). In the present embodiment, the setting information of the gain and the offset is read from the data of the acquired recipe. In the present embodiment, the conversion formula for converting the luminance value of the image is set.

Subsequently, a lookup table is generated using the set conversion formula (step S3). In the present embodiment, the lookup table for converting the luminance value of the image is generated.

Subsequently, the generated lookup table is stored in the memory (step S4). When the recipe data is stored in the auxiliary storage device, the lookup table may also be stored in association with the data of the recipe.

Through the foregoing series of steps, the lookup table required for the preprocessing is generated. After the lookup table is generated, the alignment process is executed.

FIG. 9 is a flowchart representing an example of an order of an alignment process.

First, the image is captured (step S11). The imaging is executed under the alignment condition recorded in the recipe. That is, the imaging is executed based on the illumination condition (the setting value of illumination) and the focus condition (the setting value of focus) recorded in the recipe. Accordingly, an image (first image) obtained by imaging the wafer W is acquired. The image is an infrared image. Accordingly, even when the alignment mark that is a detection target is inside the wafer W, the detection target can still be detected (recognized) from the image.

Subsequently, preprocessing is executed on the obtained image (step S12). In the present embodiment, a process of converting the luminance values of each pixel is executed. The conversion process is executed with reference to the lookup table.

By executing the preprocessing, an image (second image) appropriate for subsequent image processing is generated. Specifically, an image with luminance appropriate for detecting an alignment mark is generated. Step S12 is an example of the preprocessing step.

Subsequently, image processing for alignment is executed on the preprocessed image (step S13). In the present embodiment, as the image processing for alignment, a process of detecting the alignment mark from the image is executed. Step S13 is an example of an image processing step.

Subsequently, based on a detection result of the alignment mark, a process of positioning the blade 42 is executed (step S14). That is, the positioning is executed on the alignment mark so that the blade 42 is located at a predetermined position relative to the alignment mark.

Through this series of steps, the alignment process is completed. Thereafter, the wafer W is machined under the machining conditions recorded in the recipe.

When the kerf checking is executed, the preprocessing is similarly executed on the image captured by the imaging unit 50. Then, image processing for the kerf checking is executed on the preprocessed image. In this case, the processing conditions of the preprocessing may be the same as or different from the processing conditions of the preprocessing for alignment. When the preprocessing is executed under different conditions, each processing condition is set and recorded in the recipe. Accordingly, an image with appropriate quality can be provided even when the quality of the image differs between the alignment and the kerf checking.

As described above, according to the dicing device 1 according to the present embodiment, the quality of an image can be automatically adjusted and optimized before the image processing. Accordingly, highly accurate image processing can be executed stably.

By recording the preprocessing conditions in the recipe, optimal processing conditions can be individually set for each workpiece. Accordingly, it is possible to implement a smooth and seamless process from the start to the end of the machining.

### Second Embodiment

In the dicing device 1 according to the first embodiment, an image (second image) appropriate for imaging processing is generated by executing preprocessing on the image (first image) captured by the imaging unit 50 under the processing conditions recorded in the recipe.

In the dicing device according to the present embodiment, the processing conditions recorded in the recipe are changed step by step, and preprocessing is executed under a plurality of different processing conditions, one image is selected from a plurality of obtained images, and the selected image is provided for subsequent image processing. The selected image is an image most appropriate for image processing. That is, by varying the conditions and executing a plurality of steps of preprocessing, the optimal processing conditions and an image are extracted.

Since a basic structure of the device is the same as that of the dicing device 1 according to the first embodiment, only a configuration related to differences, that is, a configuration related to preprocessing, will be described here.

### [Configuration of Preprocessing Unit]

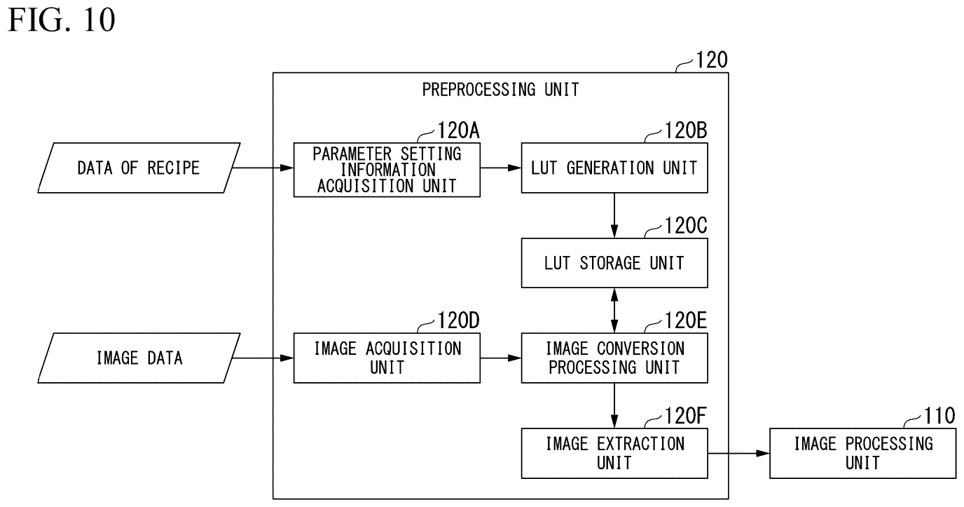

FIG. 10 is a block diagram representing a main function of the preprocessing unit.

As illustrated in FIG. 10, the preprocessing unit 120 has functions of a parameter setting information acquisition unit 120A, a lookup table generation unit 120B, a lookup table storage unit 120C, an image acquisition unit 120D, an image conversion processing unit 120E, and an image extraction unit 120F. The functions of the parameter setting information acquisition unit 120A, the lookup table generation unit 120B, the image acquisition unit 120D, the image conversion processing unit 120E, and the image extraction unit 120F are implemented by a processor included in the preprocessing unit 120 executing a predetermined program. The lookup table storage unit 120C is implemented by a memory or an auxiliary storage device included in the preprocessing unit 120.

The parameter setting information acquisition unit 120A acquires setting information for parameters included in a conversion formula, that is, setting information for a gain and an offset. The parameter setting information acquisition unit 120A acquires data of a recipe and acquires information regarding setting values of the gain and the offset included in the data of the recipe.

The lookup table generation unit 120B sets a plurality of conversion formulae based on the setting information for the parameters acquired by the parameter setting information acquisition unit 120A and generates a plurality of lookup tables using the plurality of set conversion formulae. That is, by varying the conditions and setting the plurality of conversion formulae, the plurality of lookup tables are generated.

In the present embodiment, the plurality of conversion formulae are set by varying parameters according to predetermined conditions. For example, by using a parameter setting value (α) acquired by the parameter setting information acquisition unit 120A as a reference, the parameters are varied a defined number of times (n times in the positive direction and n times in the negative direction) with a regulated change amount (Δ). That is, α−nΔ, α−(n−1)Δ, . . . , α−2Δ, α−Δ, α, α+Δ, α+2Δ, . . . , α+(n−1)Δ, and α+nΔ are obtained.

In the present embodiment, since the conversion formula includes two parameters (the gain and the offset), the plurality of conversion formulae are set by changing the two parameters step by step. That is, the plurality of conversion formulae are set by changing the two parameters of the gain and the offset step by step.

The lookup table storage unit 120C stores the plurality of lookup table generated by the lookup table generation unit 120B.

The image acquisition unit 120D acquires image data output from the imaging unit 50 and acquires a processing target image.

The image conversion processing unit 120E executes a quality conversion process on an image (first image) acquired by the image acquisition unit 120D using the plurality of lookup tables. In the present embodiment, the quality refers to luminance. The image conversion processing unit 120E performs the quality conversion process for each lookup table generated by the lookup table generation unit 120B. For example, the image conversion processing unit 120E generates an image (second image) with the converted quality in sequence with reference to the lookup table in the generation order. The generated image is added to the image extraction unit 120F in sequence.

The image extraction unit 120F extracts the image with the most appropriate quality for image processing in the image processing unit 110 from the plurality of images (second images) subjected to the quality conversion process by the image conversion processing unit 120E. As an example, in the present embodiment, an image with highest contrast is extracted as an image that is easiest to recognize.

For example, the image extraction unit 120F ultimately extracts an image with the highest quality (the image most appropriate for image processing) by comparing the quality between two images in the input order and retaining the image with relatively higher quality. For instance, the quality of the first generated image is compared with that of the second generated image. When the first generated image has higher quality, the quality of the first generated image is compared with that of the third generated image. In this way, by retaining the image with higher quality and comparing the quality of each image in sequence, an image with highest quality can be extracted.

The image extracted by the image extraction unit 120F is output to the image processing unit 110. The image processing unit 110 executes predetermined image processing on the extracted image. The predetermined image processing is, for example, image processing for alignment, image processing for kerf checking, or the like.

### [Operational Effects of Dicing Device]

Here, only operations related to preprocessing will be described. Specifically, a process of generating a lookup table and a preprocessing method using the generated lookup table will be described.

### [Process of Generating Lookup Table]

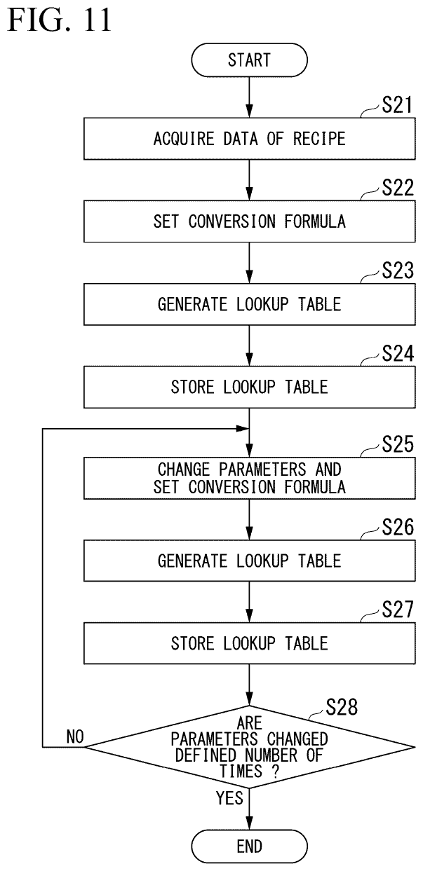

FIG. 11 is a flowchart representing an example of an order of a process of generating a lookup table.

First, the data of the recipe is acquired (step S21).

Subsequently, parameter information to be set in the conversion formula is read from the acquired recipe data, and the conversion formula is set (Step S22). In the present embodiment, gain and offset setting information is read from the acquired recipe data. This conversion formula becomes the reference conversion formula. The parameters set in this reference conversion formula become the reference parameters.

Subsequently, using the set conversion formula (the reference conversion formula), a reference lookup table is generated (Step S23).

Subsequently, the generated lookup table is stored in memory (Step S24).

Subsequently, the parameters are changed under predetermined conditions to set a new conversion formula (step S25). In the present embodiment, the new conversion formula is set by changing the parameters with a defined change amount.

Subsequently, the lookup table is generated using the newly set conversion formula (step S26).

Subsequently, the newly generated lookup table is stored in the memory (step S27).

Subsequently, it is determined whether the parameters have been changed a defined number of times (step S28). That is, it is determined whether planned changing is all completed.

When it is determined that the parameters have not been changed the defined number of times, the process returns to step S25. Then, the parameters are changed and a new conversion formula is set (step S25). Then, a lookup table is generated using the newly set conversion formula (step S26) and the generated lookup table is stored in the memory (step S27).

Conversely, when it is determined that the parameters have been changed the defined number of times, the lookup table generation process is completed.

Through the foregoing series of steps, the plurality of lookup tables necessary for the preprocessing are generated.

### [Preprocessing Method]

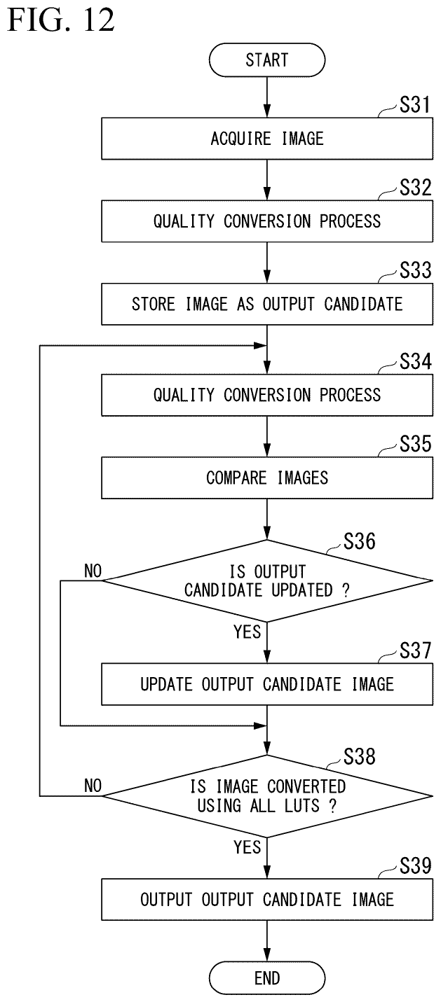

FIG. 12 is a flowchart representing an example of an order of a preprocessing process.

First, an image (first image) captured by the imaging unit 50 is acquired (step S31). The image is an infrared image.

Subsequently, the quality conversion process is executed on the obtained image (step S32). In the present embodiment, a luminance conversion process is executed. The quality conversion process is executed using the lookup table. The lookup table is used in the generation order. Accordingly, at first, the conversion process is performed using a reference lookup table.

Subsequently, the image (second image) with the converted quality is stored as an output candidate image in the memory (step S33). The “output candidate image” is a candidate image output to the image processing unit 110.

Subsequently, the lookup table to be used is changed, and the quality conversion process is executed again (step S34). The lookup table to be used is a lookup table subsequent in the order of generation. That is, the lookup table to be used is the immediately previous lookup table.

Subsequently, quality of the image newly generated through the conversion process is compared with that of the output candidate image (step S35). That is, it is determined which quality is more appropriate for image processing by the image processing unit 110. In the present embodiment, an image with higher contrast is determined to be an image with higher quality (an image more appropriate for image processing).

As a result of the comparison, it is determined whether it is necessary to update the output candidate image (step S36). When the newly generated image has higher quality (the case of an image appropriate for image processing), it is determined that it is necessary to update the output candidate image. Conversely, when the output candidate image has higher quality, it is determined that it is not necessary to update the output candidate image.

When it is determined that it is necessary to update the output candidate image, the output candidate image is updated (step S37). That is, the newly generated image is newly stored as the output candidate image in the memory.

After the updating is completed, it is determined whether the quality conversion process is executed using all the lookup tables (step S38). Even when it is determined in step S36 that it is necessary to update the output candidate image, it is determined whether the quality conversion process is executed using all the lookup tables (step S38).

When the quality conversion process is not performed using all the lookup tables, that is, when there is an unused lookup table, the process returns to step S34, the lookup table is changed, and the quality conversion process is performed again. Conversely, when there is no unused lookup table, the image held as an output candidate is output to the image processing unit 110 (step S39).

Through the foregoing series of steps, the preprocessing is completed. The image output to the image processing unit 110 is a highest-quality image (the image most appropriate for the image processing) selected from a plurality of images generated by varying the parameters. Accordingly, high-accurate image processing can be executed stably by the image processing unit 110.

As described above, in the present embodiment of the dicing device, the preprocessing conditions are automatically adjusted to obtain an image more appropriate for the image processing. Accordingly, it is possible to stably execute the high-accurate image processing.

When the data of the recipe is stored in the auxiliary storage device, it is preferable to update or add information regarding the preprocessing conditions (in the present embodiment, the setting information for the gain and the offset) as necessary. That is, when the processing conditions of the image finally output to the image processing unit 110 are different from the processing conditions recorded in the recipe, it is preferable to execute overwriting to the processing conditions or add the processing conditions. Accordingly, when the same type of wafer W is machined or the machining is executed under the same processing conditions, more optimum processing conditions can be initially set.

When the lookup table is generated and the quality conversion process is executed as in the present embodiment, information regarding the lookup table used to generate the image output to the image processing unit 110 may be stored in association with the recipe.

When the data of the recipe stored in the auxiliary storage device is read and used, and the information regarding the preprocessing conditions is updated, a parameter adjustment process may be unnecessary. In this case, the preprocessing is executed on the captured image using the information regarding the updated processing conditions, and the preprocessed image is output to the image processing unit 110 as it is. On the other hand, when the preprocessing is executed using information regarding the updated processing conditions and the parameter adjustment process is re-executed, the processing conditions can be further optimized with each iteration. When the processing conditions are not updated despite the re-execution of the parameter adjustment process, the processing conditions recorded in the recipe may be regarded as being optimized, and a subsequent adjustment process may be unnecessary.

In the foregoing embodiment, a method of comparing qualities of two images is adopted as a method of extracting an image to be output to the image processing unit 110, but a method of extracting an image is not limited thereto. A plurality of images may be collectively compared and an image most appropriate for the image processing may be extracted. When an image is extracted, a trained model may be used for the extraction. The trained model is a machine-trained model so that an image most appropriate for the image processing is extracted.

In the foregoing embodiment, the case in which an image with highest contrast is extracted as the image most appropriate for the image processing has been described, but a method of extracting the most appropriate image is not limited thereto. The method is appropriately set in accordance with content of the image processing executed subsequently by the image processing unit 110.

### Other Embodiments

In the foregoing embodiment, the case in which the image processing such as alignment or kerf checking is executed has been described as an example, but content of the image processing is not limited thereto. Various types of image processing are included.

Also, in the foregoing embodiment, the case in which the luminance of an image is changed as the preprocessing has been described as an example, but content of the preprocessing is not limited thereto. The preprocessing is performed according to subsequent image processing.

Moreover, in the foregoing embodiment, the case in which the gain and the offset of an image are changed has been described as an example of the change in luminance, but a scheme of changing luminance is not limited thereto. For example, the luminance may also be changed by changing an amount of infrared rays or changing an exposure time when imaging is executed by the camera unit 38. While both the gain and the offset are changed in the foregoing embodiment, only one of the gain and the offset may be changed.

In the foregoing embodiment, the case in which the lookup table is generated and the luminance is converted has been described as an example, but the luminance can also be converted using a conversion formula.

In the foregoing embodiment, the case in which the present invention is applied to the dicing device has been described as an example, but the application of the present invention is not limited thereto. The present invention can be applied to any type of machining device that has a function of imaging a workpiece using transmissive electromagnetic waves (for example, infrared rays, X-rays, or the like). The present invention can also be applied to dicing devices, so-called laser dicers, that machine workpieces using lasers.

### REFERENCE SIGNS LIST

1 Dicing Device
2 Base
3 Column
10 Workpiece table
10A Holding surface
12 Workpiece table drive motor
30X X-axis feed mechanism
30Y Y-axis feed mechanism
30Z Z-axis feed mechanism
32X X-axis guide rail
32Y Y-axis guide rail
32Z Z-axis guide rail
34X X-axis table
34Y Y-axis table
34Z Z-axis table
36X X-axis actuator
36Y Y-axis actuator
36Z Z-axis actuator
40 Machining unit
42 Blade
44 Spindle
46 Spindle motor
48 Bracket
50 Imaging unit
51 Microscope unit
51A Beam splitter
51B Objective lens
51C Imaging lens
52 Light source unit
52A light source
52B light source lens
53 Camera unit
53A Image sensor
100 Control unit
110 Image processing unit
110A Alignment unit
110B Kerf checking unit
120 Preprocessing unit
120A Parameter setting information acquisition unit
120B Lookup table generation unit
120C Lookup table storage unit
120D Image acquisition unit
120E Image conversion processing unit
120F Image extraction unit
130 Display unit
140 Manipulation unit
150 Communication unit
DF Dicing frame
DT Dicing tape
L0 Graph of conversion formula f0(x)
L1 Graph when parameter of gain of conversion formula f0(x) is changed
L2 Graph when parameter of offset of conversion formula f0(x) is changed
W Wafer

1. A machining device that acquires data including information regarding a machining condition of a workpiece and machines the workpiece under the machining condition recorded in the acquired data, the machining device comprising:
an irradiation unit configured to irradiate the workpiece with electromagnetic waves capable of transmitting through the workpiece;
an imaging unit configured to image the workpiece irradiated with the electromagnetic waves;
a preprocessing unit configured to generate a second image by executing preprocessing on a first image obtained by the imaging; and
an image processing unit configured to execute image processing on the second image,
wherein the data includes information regarding a processing condition of the preprocessing, and
wherein the preprocessing unit generates the second image by executing preprocessing on the first image under the processing condition recorded in the data.

2. The machining device according to claim 1, wherein the preprocessing unit executes a process of converting luminance as the preprocessing.

3. The machining device according to claim 2, wherein the preprocessing unit
generates a table for converting luminance of the first image under the processing condition, and
converts the luminance of the first image with reference to the generated table.

4. The machining device according to claim 3,
wherein the preprocessing unit generates the table using a conversion formula in which a gain and/or an offset is included in a parameter, and
wherein the data includes information regarding the gain and/or the offset set with the conversion formula as the information regarding the processing condition.

5. The machining device according to claim 4, wherein the preprocessing unit
generates a plurality of the tables by changing the gain and/or the offset step by step under a predetermined condition,
generates a plurality of the second images by converting the luminance of the first image using the plurality of generated tables, and
extracts one second image most appropriate for the image processing by the image processing unit among the plurality of generated second images.

6. The machining device according to claim 1, wherein the image processing unit executes alignment image processing on the second image.

7. The machining device according to claim 1, further comprising a condition reception unit configured to receive the machining condition and the processing condition.

8. The machining device according to claim 1, wherein the irradiation unit irradiates the workpiece with infrared rays as the electromagnetic waves.

9. The machining device according to claim 1, wherein the workpiece is machined along a planned division line.

10. The machining device according to claim 9, wherein the workpiece is machined along the planned division line with a rotating blade or a laser.

11. The machining device according to claim 1, wherein the data further includes at least one of information regarding the workpiece and information regarding an alignment condition.

12. The machining device according to claim 11,
wherein the information regarding the alignment condition includes information regarding an irradiation amount of the electromagnetic waves and focus setting information during the imaging by the imaging unit, and
wherein the machining device further comprises:
an irradiation control unit configured to control irradiation of the electromagnetic waves by the irradiation unit based on the data; and
an imaging control unit configured to control the imaging by the imaging unit based on the data.

13. An image processing method of processing an image captured by irradiating a workpiece with electromagnetic waves capable of transmitting through the workpiece in a machining device that acquires data including information regarding a machining condition of the workpiece and machines the workpiece under the machining condition recorded in the acquired data, the image processing method comprising:
a preprocessing step of generating a second image by executing preprocessing on a first image obtained by the imaging; and
an image processing step of executing image processing on the second image,
wherein the data includes information regarding a processing condition of the preprocessing, and
wherein, in the preprocessing step, the second image is generated by executing preprocessing on the first image under the processing condition recorded in the data.

14. The image processing method according to claim 13,
wherein the preprocessing step includes
a step of generating a table for converting luminance of the first image using a conversion formula in which a gain and/or an offset is included in a parameter, and
a step of converting the luminance of the first image with reference to the generated table, and
wherein the data includes information regarding the gain and/or the offset set with the conversion formula as the information regarding the processing condition.

15. The image processing method according to claim 14, wherein the preprocessing step further includes
a step of generating a plurality of the tables by changing the gain and/or the offset step by step under a predetermined condition,
a step of generating a plurality of the second images by converting the luminance of the first image using the plurality of generated tables, and
a step of extracting one second image most appropriate for the image processing by the image processing unit among the plurality of generated second images.
